(19) United States
(12) Patent Application Publication
(10) Pub. No.: US 2023/0055430 A1
(43) Pub. Date: Feb. 23, 2023

(54) SUPRAMOLECULAR ADDITIVES FOR SEMICRYSTALLINE PLASTICS

(71) Applicants: Li Jia, Hudson, OH (US); Honghe Liang, Akron, OH (US); Toshikazu Miyoshi, Akron, OH (US); James Eagan, Akron, OH (US)

(72) Inventors: Li Jia, Hudson, OH (US); Honghe Liang, Akron, OH (US); Toshikazu Miyoshi, Akron, OH (US); James Eagan, Akron, OH (US)

(21) Appl. No.: 17/882,761

(22) Filed: Aug. 8, 2022

Related U.S. Application Data
(60) Provisional application No. 63/230,126, filed on Aug. 6, 2021.

(51) Int. Cl. C08L 23/36; C08F 8/32; C08F 210/06; C08G 63/91; C08L 67/02

(52) U.S. Cl. CPC C08L 23/36; C08F 8/32; C08F 210/06; C08G 63/916; C08L 67/02

(57) ABSTRACT

A semicrystalline plastic composition comprising: a semicrystalline plastic and an additive dispersed therein. The semicrystalline plastic includes a polymeric chain comprising repeat units of an oligomeric or polymeric chain and the additive comprises a supramolecular building block and an oligomeric or polymeric tail. The oligomeric or polymeric tail of the additive having the same repeat units as the polymeric chain of the semicrystalline plastic. The additive forming a plurality of sheet-like structures through hydrogen bonding. The sheet-like structures, interacting through non-covalent interaction, form crystallized additive domains within the semicrystalline plastic.

### CROSS-REFERENCE TO RELATED APPLICATIONS

The present application claims priority to U.S. Provisional Patent Application Ser. No. 63/230,126 filed Aug. 6, 2021, the entirety of which is incorporated herein by reference.

### FIELD OF THE INVENTION

The present invention relates to the use of supramolecular additives for inducing crystallization of semicrystalline plastics.

### BACKGROUND OF THE INVENTION

Crystallinity, melt temperature, crystallization temperature, crystallization rate, crystal spherulite size, crystal spherulite shape, and the size of the crystal lamella are all key properties that govern the processing conditions and end performances of semicrystalline polymers. Specifically, the crystallization of semicrystalline polymers can be influenced by adding nucleating agents and subjecting the polymer melt to shear or flow. Typically, nucleating agents increase the rate and temperature of crystallization via epitaxy crystallization of the semicrystalline polymers.

Up until the present invention, the rational design and discovery of nucleating agents was impossible. The present invention employs supramolecular additives to chemically stretch the polymer chains that are covalently tethered to the surface of the supramolecular crystals. The present invention allows for the rational design of nucleating agents for specific types of semicrystalline plastics. The supramolecular crystals can also potentially reinforce the plastic composite.

The benefits of using a supramolecular building block as an additive have been demonstrated in the rubber field. U.S. Pat. No. 9,982,117 to The University of Akron shows supramolecular building blocks that form β-sheet crystals for reinforcing thermoset rubbers. While U.S. Pat. No. 9,527,964 to The University of Akron shows supramolecular crystalline domains, in particular those formed by oligopeptide β-sheets for reinforcing thermoplastic elastomers. However, the use of a supramolecular additive has not been used to induce crystallization of and benefit semicrystalline plastics.

### SUMMARY OF THE INVENTION

An embodiment of the present invention provides a semicrystalline plastic composition comprising: a semicrystalline plastic and an additive dispersed therein, wherein the semicrystalline plastic includes a polymeric chain comprising repeat units of an oligomeric or polymeric chain, wherein the additive comprises a supramolecular building block and an oligomeric or polymeric tail, the oligomeric or polymeric tail having the same repeat units as the polymeric chain of the semicrystalline plastic, and wherein the additive forms a plurality of sheet-like structures through hydrogen bonding, the sheet-like structures interacting through non-covalent interaction to form crystallized additive domains within the semicrystalline plastic.

Another embodiment of the present invention provides a semicrystalline plastic composition as in any embodiment above, wherein the supramolecular building block is selected from a peptide, a β-peptide, an aramid oligomer, and a bis-urea.

Another embodiment of the present invention provides a semicrystalline plastic composition as in any embodiment above, wherein the supramolecular building block is covalently linked to the polymeric chain of the semicrystalline plastic.

Another embodiment of the present invention provides a semicrystalline plastic composition as in any embodiment above, wherein the semicrystalline plastic is selected from the group consisting of semicrystalline poly(1-alkenes), poly(3-hydroxybutyrate), polylactides, polyglycolides, polyethylene terephthalates, derivatives thereof, and mixtures thereof.

Another embodiment of the present invention provides a semicrystalline plastic composition as in any embodiment above, wherein the semicrystalline plastic is selected from the group consisting of polypropylene, high-density polyethylene, low density polyethylene, linear low-density polyethylene, poly(4-methyl-1-pentene), poly(l-butene), isotactic polystyrene, syndiotactic polystyrene, derivatives thereof, and mixtures thereof.

Another embodiment of the present invention provides a semicrystalline plastic composition as in any embodiment above, wherein the supramolecule building blocks is a β-alanine according to the following structure:

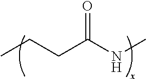

wherein x is from 1 to 8.

Another embodiment of the present invention provides a semicrystalline plastic composition as in any embodiment above, wherein the supramolecule building block is an aramid according to the following structure:

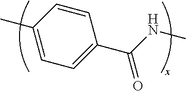

wherein x is from 1 to 8.

Another embodiment of the present invention provides a semicrystalline plastic composition as in any embodiment above, wherein the supramolecule building block is an aramid according to one of the following structures:

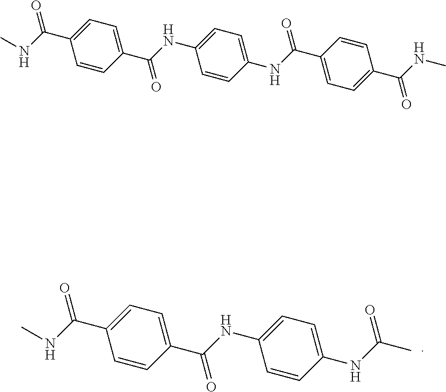

Another embodiment of the present invention provides a semicrystalline plastic composition as in any embodiment above, wherein the supramolecule building block is an aramid according to one of the following structures:

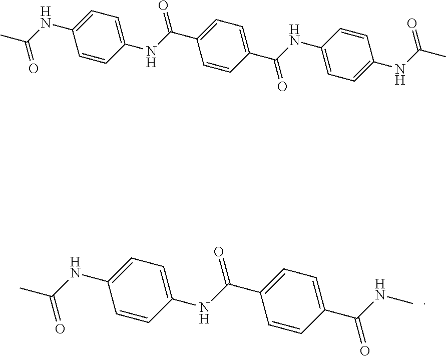

Another embodiment of the present invention provides a semicrystalline plastic composition as in any embodiment above, wherein the supramolecule building block is an aramid according to the following structure:

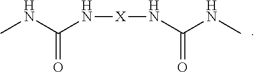

Another embodiment of the present invention provides a process of forming a semicrystalline plastic composition comprising the steps of dispersing a supramolecular building block bearing a reactive group in a semicrystalline plastic to form a mixture, wherein the semicrystalline plastic includes a polymeric chain; and subjecting said mixture to reaction conditions that allow the supramolecular building block to be covalently linked to the polymeric chain of the semicrystalline plastic via a reaction between said reactive group of the supramolecular building block and the polymeric chain of said semicrystalline plastic.

### BRIEF DESCRIPTION OF THE DRAWINGS

For a more complete understanding of the features and advantages of the present invention, reference is now made to the detailed description of the invention along with the accompanying figures in which:

FIG. 1 is a graph of the ¹H NMR spectra of the peak assignments of vinylidene-terminated polypropylene (PP), carboxylic acid-terminated PP, βA₁-terminated PP, and βA₂-terminated PP in CDCl₃ along with the accompanying structures in the inset.

FIG. 2 is a DSC graph of the second heating-cooling cycle for vinylidene-terminated PP, βA₁-terminated PP, and a 1:1 blend of vinylidene-terminated PP and βA₁-terminated PP.

FIG. 3 is a DSC graph of the second heating-cooling cycle for vinylidene-terminated PP, βA₂-terminated PP, and a 1:1 blend of vinylidene-terminated PP and βA₂-terminated PP.

FIG. 4 is a solid state ¹H broadline NMR spectra for vinylidene-terminated PP, βA₁-terminated PP, and the 1:1 blend of vinylidene-terminated PP and βA₁-terminated PP taken at 25° C.

FIG. 5 is an ¹H NMR spectrum of PHB-βA3 in CDCl₃.

FIG. 6 shows POM graphs of blends of PHB and PHB-βA3 (scale bar: 500 μm) wherein the weight percent of PHB-βA3 in each blend is as indicated

FIG. 7 shows POM graphs of blends of PHB and low molecular weight PHB (scale bar: 500 μm) wherein the weight percent of the low molecular weight PHB in each blend is as indicated in the diagrams.

FIG. 8 shows a graph of the tensile modulus versus time for a pure PHB sample; a blend of pure PHB and 5% PHB-βA3; a blend of pure PHB and 10% PHB-βA3; a blend of pure PHB and 5% low molecular weight PHB; and a blend of PHB and 10% low molecular weight PHB.

FIG. 9 shows a graph of crystallinity vs. time for a pure PHB sample; a blend of pure PHB and 5% PHB-βA3; a blend of pure PHB and 10% PHB-βA3; a blend of pure PHB and 5% low molecular weight PHB; and a blend of PHB and 10% low molecular weight PHB.

### DETAILED DESCRIPTION OF ILLUSTRATIVE EMBODIMENTS

The present invention is directed to the use of supramolecular additives to induce crystallization of semicrystalline plastics. The supramolecular additive comprises a supramolecular building block and a polymeric or oligomeric tail covalently connected to the supramolecular building block. The polymeric or oligomeric tail will be chosen based on the semicrystalline plastic that the supramolecular additive is to be added to, with the polymeric or oligomeric tail having the same repeat units as the polymeric chain of the semicrystalline plastic, for controlling the crystallization and crystallinity of the semicrystalline plastics. The supramolecular additives are incorporated into the semicrystalline plastics and form a plurality of sheet-like structures through hydrogen bonding. Those sheets then stack to form supramolecular crystals. The polymeric or oligomeric tails, which are covalently attached to the surfaces of the supramolecular crystals, are then stretched, with the stretched chains inducing crystallization of the plastics.

The additives are selected based on the ability of the supramolecular building block being able to self-assemble into sheet-like secondary structures through hydrogen bonding. These sheet-like structures then interact through non-covalent interactions, such as van der Waals forces and dipole-dipole interactions to form the crystallized domains (nanoassemblies) within the semicrystalline plastics.

The semicrystalline plastics utilized in the present invention may be virtually any semicrystalline plastic. In some embodiments, the semicrystalline plastic is selected from the group consisting of semicrystalline poly(l-alkenes), poly(3-hydroxybutyrate), polylactides, polyglycolides, polyethylene terephthalates, derivatives thereof, and mixtures thereof. As such, the tail of the supramolecular additive applied to the above semicrystalline plastics has the same repeat units as the respective semicrystalline plastics.

In some embodiments, the semicrystalline plastic is selected from the group consisting of polypropylene, high-density polyethylene, low density polyethylene, linear low-density polyethylene, poly(4-methyl-1-pentene), poly(l-butene), isotactic polystyrene, syndiotactic polystyrene, derivatives thereof, and mixtures thereof.

In some embodiments, the supramolecular building block of the additive is selected from the group consisting of a peptide, a β-peptide, an aramid oligomer, and a bis-urea. In some embodiments, the supramolecular building block of the additive is selected from the group consisting of peptides having 1 to 10 amino acid residues. In some embodiments, the supramolecular building block is a peptide, and the peptide is selected from the group consisting of alanine, β-alanine, alanine-glycine, leucine, and isoleucine. In other embodiments, the supramolecular building block is ab oligo-β-alanine. In other embodiments, the supramolecular building block is an aramid oligomer. In yet other embodiments, the supramolecular building block is a bis-urea.

In some embodiments, the supramolecule building block is a β-alanine according to the following structures:

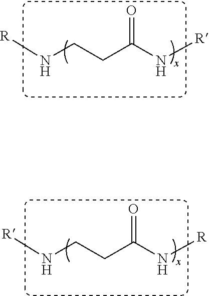

where the structural motif enclosed in the dotted frame is the supramolecule building block, wherein x is not to be limited to any particular number. In some embodiments, x will be from 1 to 10. In some embodiments, x will be from 2 to 6. In some embodiments, x will be from 2 to 4. This structure forms stacked β-sheets (beta sheets) through hydrogen bonding. These sheets associate into nanoassemblies through van der Waal forces and dipole-dipole interactions that segregate from the semicrystalline plastic to form crystalline domains. The R and R′ groups may be the same or different and at least one is a moiety suitable for conducting a method of linking the supramolecule building block to the semicrystalline plastic as described herein. In some embodiments, both R and R′ will be suitable for covalently linking the supramolecule building block to a semicrystalline plastic as describe more fully herein below. In other embodiments, one R group is a non-reactive group chosen to avoid reacting with a semicrystalline plastic, while the other R group is suitable for covalently linking the supramolecule building block to a semicrystalline plastic as describe more fully herein below.

In some embodiments, the supramolecule building block is an aramid according to the following structures:

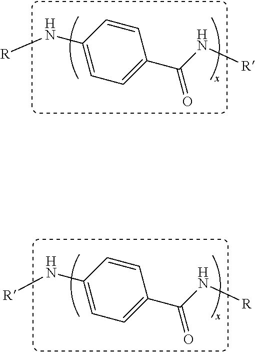

where the structural motif enclosed in the dotted frame is the supramolecule building block, wherein x is not to be limited to any particular number. In some embodiments, x will be from 1 to 10. In some embodiments, x will be from 2 to 6. In some embodiments, x will be from 2 to 4. This structure forms sheets through hydrogen bonding. These sheets associate into nanoassemblies through van der Waal forces and dipole-dipole interactions that segregate from the semicrystalline plastic to form crystalline domains. The R and R′ groups may be the same or different and represent any moiety suitable for conducting a method of linking the supramolecule building block to the semicrystalline plastic as described herein. In some embodiments, both R and R′ will be suitable for covalently linking the supramolecule building block to a semicrystalline plastic as describe more fully herein below. In other embodiments, one R group is a non-reactive group chosen to avoid reacting with a semicrystalline plastic, while the other R group is suitable for covalently linking the supramolecule building block to a semicrystalline plastic as describe more fully herein below.

In some embodiments, the supramolecule building block is an aramid according to the following structures:

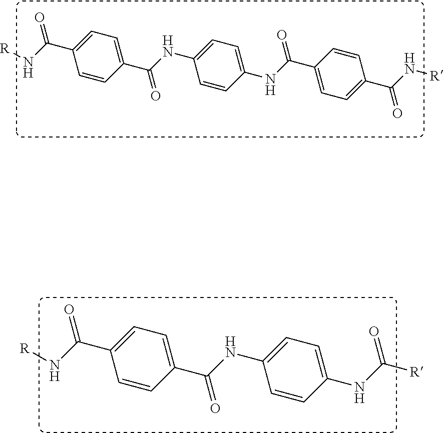

where the structural motif enclosed in the dotted frame is the supramolecule building block. This structure forms antiparallel stacked sheets through hydrogen bonding. These sheets associate into nanoassemblies through van der Waal forces and dipole-dipole interactions that segregate from the semicrystalline plastic to form crystalline domains. The R and R′ groups may be the same or different and represent any moiety suitable for conducting a method of linking the supramolecule building block to the semicrystalline plastic as described herein. In some embodiments, both R and R′ will be suitable for covalently linking the supramolecule building block to a semicrystalline plastic as describe more fully herein below. In other embodiments, one R group is a non-reactive group chosen to avoid reacting with a semicrystalline plastic, while the other R group is suitable for covalently linking the supramolecule building block to a semicrystalline plastic as describe more fully herein below.

In some embodiments, the supramolecule building block is an aramid according to the following structures:

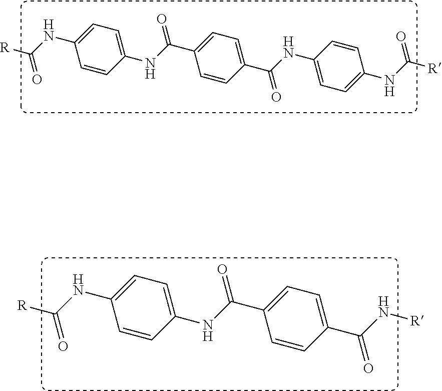

where the structural motif enclosed in the dotted frame is the supramolecule building block, R is a covalently linking unit, and R′ is an end cap, as discussed above; or R and R′ are both covalently linking units. This structure forms antiparallel stacked through hydrogen bonding. These sheets associate into nanoassemblies through van der Waal forces and dipole-dipole interactions that segregate from the semicrystalline plastic to form crystalline domains. The R and R′ groups may be the same or different and represent any moiety suitable for conducting a method of linking the supramolecule building block to the semicrystalline plastic as described herein. In some embodiments, both R and R′ will be suitable for covalently linking the supramolecule building block to a semicrystalline plastic as describe more fully herein below. In other embodiments, one R group is a non-reactive group chosen to avoid reacting with a semicrystalline plastic, while the other R group is suitable for covalently linking the supramolecule building block to a semicrystalline plastic as describe more fully herein below.

In some embodiments, the supramolecule building block is an aramid according to the following structure:

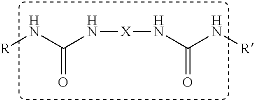

where the structural motif enclosed in the dotted frame is the supramolecule building block, X is an alkylene or arylene group containing 2 to 8 carbon atoms. This structure forms antiparallel stacked sheets through hydrogen bonding. These sheets associate into nanoassemblies through van der Waal forces and dipole-dipole interactions that segregate from the semicrystalline plastic to form crystalline domains. The R and R′ groups may be the same or different and represent any moiety suitable for conducting a method of linking the supramolecule building block to the semicrystalline plastic as described herein. In some embodiments, both R and R′ will be suitable for covalently linking the supramolecule building block to a semicrystalline plastic as describe more fully herein below. In other embodiments, one R group is a non-reactive group chosen to avoid reacting with a semicrystalline plastic, while the other R group is suitable for covalently linking the supramolecule building block to a semicrystalline plastic as describe more fully herein below.

In some embodiments, the supramolecular building block of the additive bears a reactive group, and this additive is dispersed within a semicrystalline plastic to create a first mixture. This first mixture is then subjected to reaction conditions that allow the supramolecular building block to be covalently connected to the polymeric chains of the semicrystalline plastic via a reaction between the reactive group of the supramolecular building block and the polymeric chains of the semicrystalline plastic.

In light of the foregoing, it should be appreciated that the present invention significantly advances the art by providing a semicrystalline plastic composition that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### Examples

Intermediates H₂N-βA₁-ⁿBu, H₂N-βA₂-ⁿBu, and H₂N-βA₃-ⁿBu shown below were synthesized using procedures previously established for similar compounds (Joseph J. Scavuzzo Ph.D. Dissertation, The University of Akron, 2014).

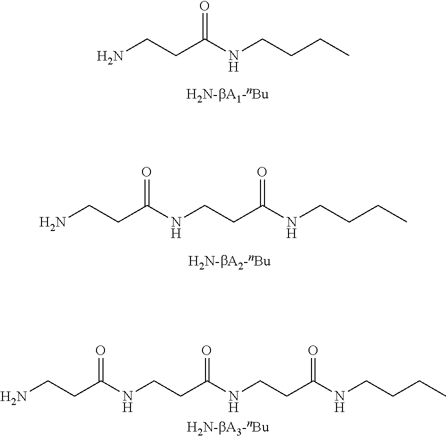

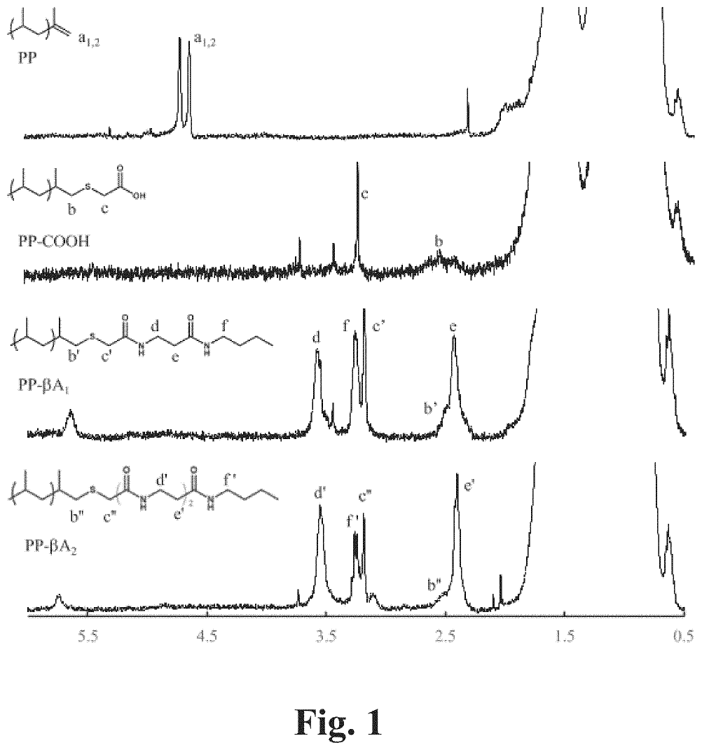

To begin a first experiment, vinylidene-terminated polypropylene was synthesized using a homogenous catalyst which terminates polymerization by beta-hydrogen elimination instead of transmetallation to cocatalyst. In the present examples, this was done using an ansa-metallocene catalyst (well known in the art) at an elevated temperature of 80° C. in toluene and modified methylaluminoxane (MMAO-12) cocatalyst. The resultant polypropylene has a number-average molecular weight (Mₙ) of 2800 g/mol and polydispersity index (PDI) of 2.90 according to GPC relative to PS standards adjusted to PP using Mark-Houwink approximation. The ¹H NMR spectra of vinylidiene-terminated polypropylene (PP), carboxylic acid-terminated polypropylene (PP—COOH), β-alanine₁-terminated polypropylene (PP-βA₁), and β-alanine₂-terminated polypropylene (PP-βA₂) in deuterated chloroform CDCl₃ are shown in FIG. 1.

To prepare the carboxylic acid-terminated polypropylene discussed above, vinylidene-terminated PP (1.00 g, 0.71 mmol), DMPA (0.06 g, 1 wt. %), and 3 mL chloroform (CHCl₃) were charged in a 25 mL Schlenk flask. After dissolution, thiol glycolic acid (0.3 ml, 4.26 mmol) was added, and the contents were shaken for 20 min. The sample was then irradiated using a UV light (365 nm) for approximately 10 minutes. The resulting solution was poured into methanol (50 ml) to precipitate the product. The product was dried in a vacuum oven overnight at room temperature (0.8 g, 80%).

To prepare the β-alanine₁-terminated polypropylene discussed above, the PP—COOH (1 g, 0.345 mmol) produced according to the steps above is dissolved into 5 ml of CHCl₃ to which was added 0.5 ml of thionyl chloride (SOCl₂). The mixture was stirred for four hours at 40° C. under N₂ protection. The solvent and the excess of SOCl₂ were removed under reduced pressure to give a light yellow soft solid (PP—COCl). The solid was dissolved with 5 ml of CHCl₃ and the solution was put into a 6 ml syringe. H₂N-βA₁-ⁿBu (0.093 g, 0.500 mmol) was dissolved into 5 ml of CHCl₃ with the help of trimethylamine (0.22 ml, 1.55 mmol). The PP—COCl solution was added to the H₂N-βA₁-ⁿBu solution dropwise and the mixture was stirred overnight at room temperature under N₂ protection. The resulting solution was poured into methanol (50 ml) to precipitate the product. The product was dried in a vacuum oven overnight at room temperature (0.7 g, 70%).

To prepare the β-alanine₂-terminated polypropylene discussed above, the PP—COOH (1 g, 0.345 mmol) produced according to the steps above is dissolved into 5 ml of CHCl₃ to which was added 0.5 ml of thionyl chloride (SOCl₂). The mixture was stirred for four hours at 40° C. under N₂ protection. The solvent and the excess of SOCl₂ were removed under reduced pressure to give light yellow soft solid (PP—COCl). The solid was dissolved with 5 ml of CHCl₃. H₂N-βA₂-ⁿBu (0.125 g, 0.500 mmol) was dissolved into 5 ml of CHCl₃ with the help of trimethylamine (0.22 ml, 1.55 mmol). The PP—COCl solution was added to the H₂N-βA₂-ⁿBu solution drop-wise via a syringe and the mixture was stirred overnight at room temperature under N₂ protection. The resulting solution was poured into methanol (50 ml) to precipitate the product. The product was dried in a vacuum oven overnight at room temperature (0.7 g, 70%).

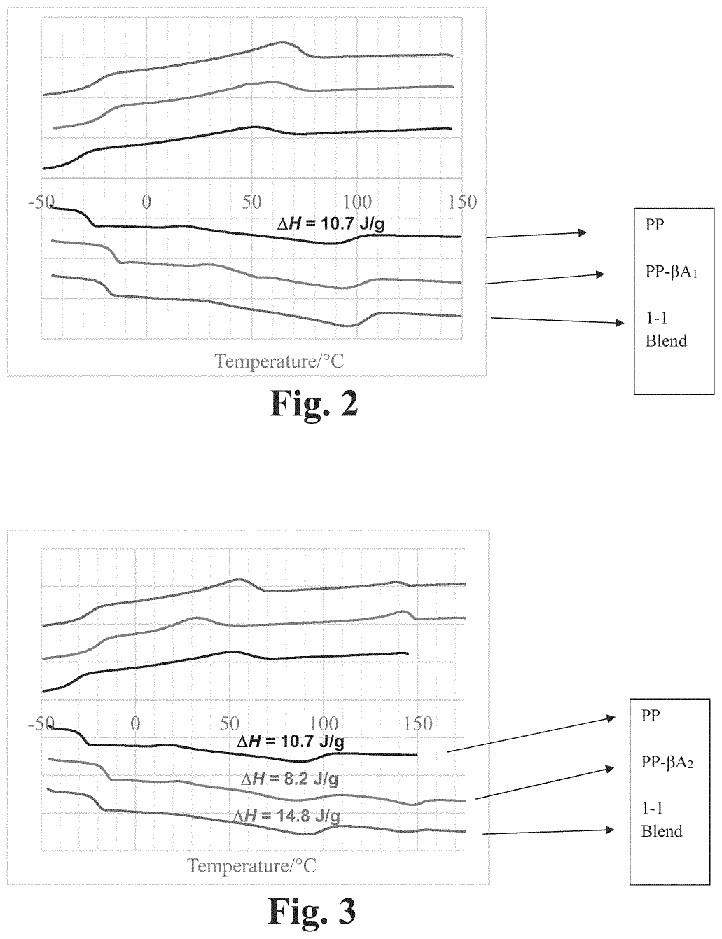

A Differential Scanning calorimetry (DSC) study was then undertaken. Vinylidene-terminated PP was used as the authentic PP sample without functionalization to compare with its 1:1 blend with PP-βA₁ and its 1:1 blend of PP-βA₂. Pure PP-βA₁ and PP-βA₂ were also studied for comparison. DSC was performed on a TA Instruments model Q250 with TA-TRIOS Universal Analysis software. The samples were heated and cooled at a rate of 5° C./min under nitrogen. The second heating and cooling cycles of PP, PP-βA₁, and their 1:1 blend are compared in FIG. 2. The crystallization temperature of PP increases from 51° C. for PP alone to 64° C. for the blend. The melt enthalpy of PP increases from 10.7 J/g for pure PP to 20.9 J/g for the blend. The second heating and cooling cycles of PP, PP-βA₂, and their 1:1 blend are compared in FIG. 3. The crystallization temperature of PP increases from 51° C. for PP alone to 54° C. for the blend. The melt enthalpy of PP increases from 10.7 J/g for pure PP to 14.8 J/g for the blend. These results indicate an increase in crystallinity of PP in the presence of PP-βA₁ or PP-βA₂.

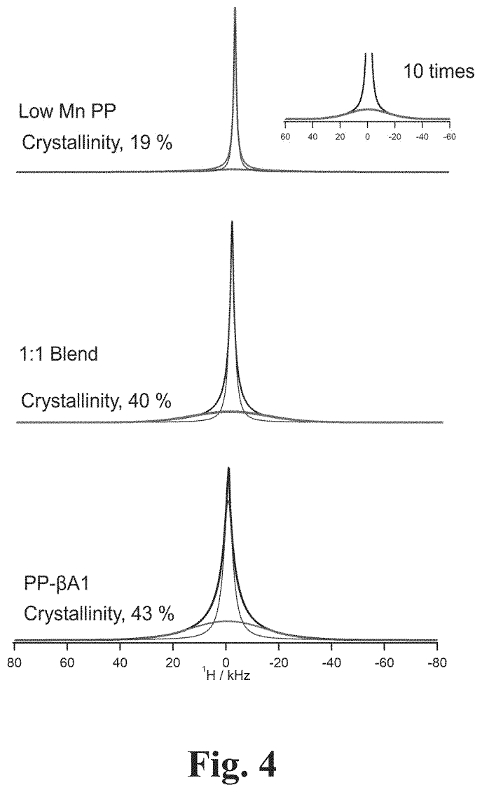

A solid-state NMR spectroscopy was then taken of each sample of vinylidene-terminated PP, βA₁-terminated PP, and the 1:1 blend of vinylidene-terminated PP and βA₁-terminated PP to determine the crystallinity of the samples. FIG. 4 shows the ¹H broad line NMR spectra of these samples. Gaussian and Lorentzian line shapes were used to fit the peaks for the crystalline and amorphous components. The resultant spectra data showed broad and sharp components which are assigned to crystalline and amorphous signals, respectively. Peak de-convolutions determined a crystallinity of 19% for the vinylidene-terminated PP (PP), 43% for the PP-βA₁, and 40% for the 1:1 blend of the two. The results support that the additives of the present invention result in the stretch induced crystallization of the semicrystalline plastics along with increased crystallinity of the semicrystalline plastic. Moreover, the amorphous signals in the blend are much broader than those of polypropylene on its own which indicates that chain mobility of the amorphous polypropylene in the blend is significantly lowered in comparison to those of pure polypropylene.

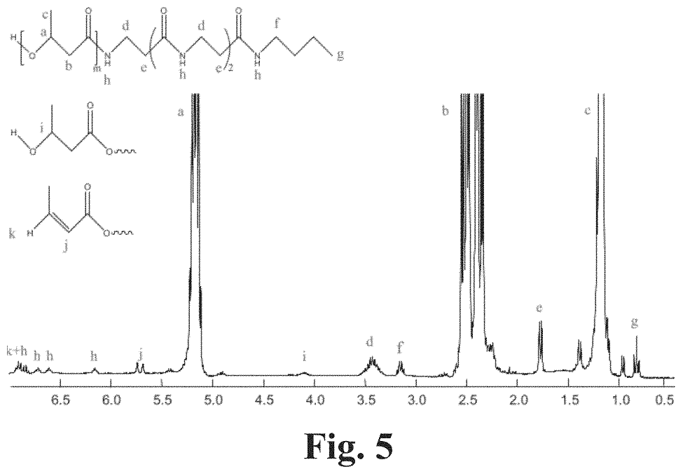

In an additional experiment, a poly(3-hydroxybutyrate) (PHB) is end-functionalized with βA₃ to form PHB-βA₃. Poly-(R)-3-hydroxybutyrate (1 g) is dissolved into 40 ml of Chlorobenzene to which was added H₂N-βA₃-ⁿBu (0.095 g, 0.332 mmol). The mixture was heated to reflux and stirred for 24 hours under N₂ protection. The resulting mixture was set at room temperature overnight to precipitate the product (0.68 g, 68%). The number average molecular weight of the formed PHB-βA₃ is 5,000 g/mol based on end group analysis, and 72% of the Poly-(R)-3-hydroxybutyrate was end-functionalized with βA₃. Proton NMR of the poly-(R)-3-hydroxybutyrate end-functionalized with βA₃ is shown in FIG. 5. The structure of PHB-β A₃ is shown at the top The peaks are assigned as indicated. Peaks i, j, and k belong to the minor fraction of PHB not end-functionalized by βA₃.

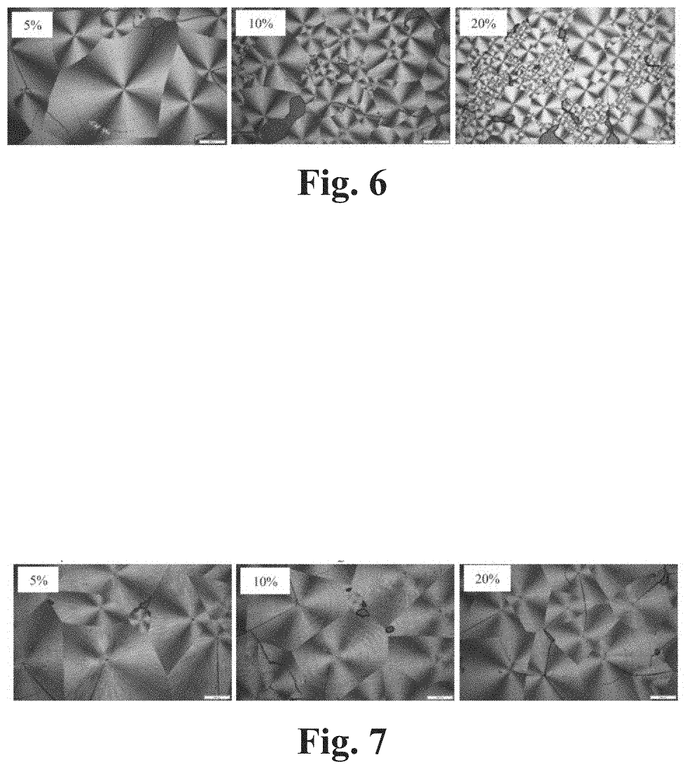

A Polarized optical microscopy (POM) study was undertaken. In this study, the Poly-(R)-3-hydroxybutyrate used to create the PHB-βA3 was combined in a blend with a low molecular weight Poly-(R)-3-hydroxybutyrate (the number average molecular weight is 5,000 g/mol based on end-group analysis) to compare with a blend prepared with the Poly-(R) hydroxybutyrate used to create the PHB-βA3 and the actual PHB-βA₃. Blends were made using 5%, 10%, and 20% of the low molecular weight Poly-(R)-3-hydroxybutyrate with the rest being Poly-(R)-3-hydroxybutyrate which were compared with blends made using 5%, 10%, and 20% of the PHB-βA3 with the rest being Poly-(R)-3-hydroxybutyrate. POM was performed on an OLYMPUS BX51 wherein the samples were heated to 190° C. and then cooled down to 80° C. and held for 40 minutes. The results of the POM study show that the nucleation density of the crystal spherulites increase with increasing concentration of PHB-βA₃ as compared to the same samples with increasing concentration of low molecular weight Poly-(R)-3-hydroxybutyrate. POM graphs of blends of PHB and PHB-βA3 are shown in FIG. 6 whereas POM graphs of blends of PHB and low molecular weight PHB are shown in FIG. 7.

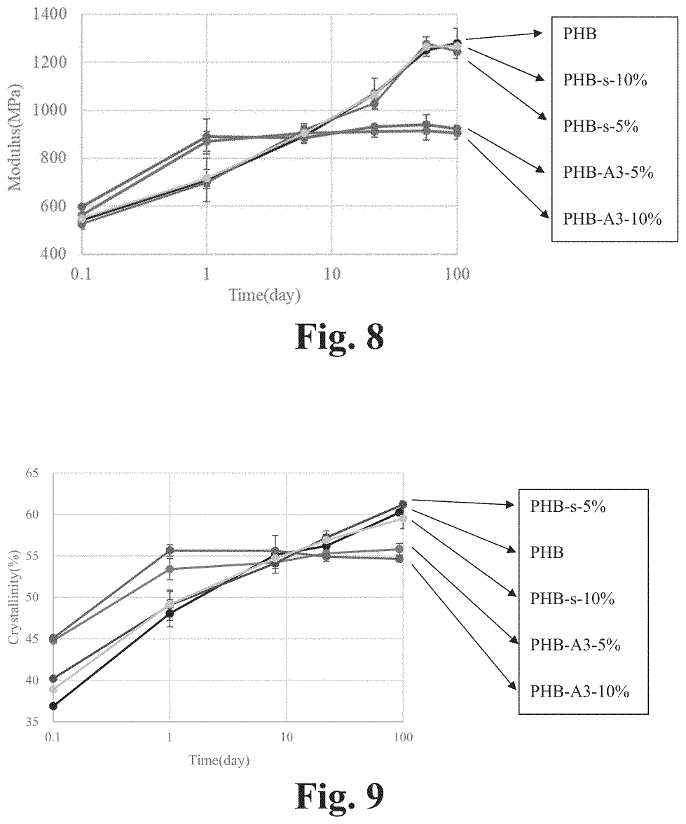

The tensile modulus was then assessed over time. The samples were heat compression molded at 185° C. for 5 minutes into a film and the formed films were then cut into dumbbell samples utilizing ASTM 638 TYPE V. At least three tensile specimens were then assessed for each sample group using an Instron model 5567 at a crosshead speed of 3.2 mm/min and an initial gap separation of 8 mm. The Young's moduli of the samples changed over time. The results showed that the blends of PHB with PHB-βA3 showed faster secondary crystallization based on the increase of modulus, as compared to pure PHB and blends of the PHB with the low molecular weight PHB. The crystallization of the blends of PHB with PHB-βA₃ was completed within a day. A plot of modulus vs time is shown in FIG. 8.

An X-ray diffraction (XRD) study was then undertaken. The samples were heat compression molded at 185° C. for 5 minutes and the XRD study was conducted with a D/maxRAPID II-S from the Rigaku Corporation. The samples utilizing PHB-βA₃ showed faster secondary crystallization as compared to samples that did not. The crystallization was also complete within 1 day, which was consistent with the Young's modulus testing discussed above. A plot of crystallinity vs time is shown in FIG. 9.

What is claimed is:

1. A semicrystalline plastic composition comprising: a semicrystalline plastic and an additive dispersed therein, wherein the semicrystalline plastic includes a polymeric chain comprising repeat units of an oligomeric or polymeric chain, wherein the additive comprises a supramolecular building block and an oligomeric or polymeric tail, the oligomeric or polymeric tail having the same repeat units as the polymeric chain of the semicrystalline plastic, and wherein the additive forms a plurality of sheet-like structures through hydrogen bonding, the sheet-like structures interacting through non-covalent interaction to form crystallized additive domains within the semicrystalline plastic.

2. The semicrystalline plastic composition of claim 1, wherein the supramolecular building block is selected from a peptide, a β-peptide, an aramid oligomer, and a bis-urea.

3. The semicrystalline plastic composition of claim 1, wherein the supramolecular building block is covalently linked to the polymeric chain of the semicrystalline plastic.

4. The semicrystalline plastic composition of claim 1, wherein the semicrystalline plastic is selected from the group consisting of semicrystalline poly(1-alkenes), poly(3-hydroxybutyrate), polylactides, polyglycolides, polyethylene terephthalates, derivatives thereof, and mixtures thereof.

5. The semicrystalline plastic composition of claim 1, wherein the semicrystalline plastic is selected from the group consisting of polypropylene, high-density polyethylene, low density polyethylene, linear low-density polyethylene, poly(4-methyl-1-pentene), poly(l-butene), isotactic polystyrene, syndiotactic polystyrene, derivatives thereof, and mixtures thereof.

6. The semicrystalline plastic composition of claim 1, wherein the supramolecule building blocks is a β-alanine according to the following structure: 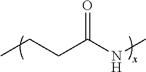
wherein x is from 1 to 8.

7. The semicrystalline plastic composition of claim 1, wherein the supramolecule building block is an aramid according to the following structure: 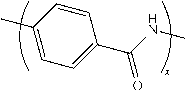
wherein x is from 1 to 8.

8. The semicrystalline plastic composition of claim 1, wherein the supramolecule building block is an aramid according to one of the following structures:

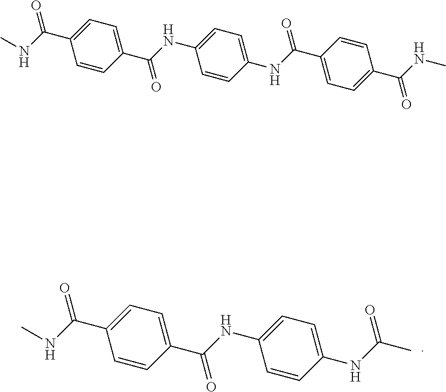

9. The semicrystalline plastic composition of claim 1, wherein the supramolecule building block is an aramid according to one of the following structures:

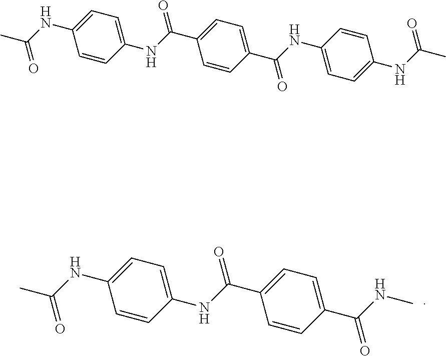

10. The semicrystalline plastic composition of claim 1, wherein the supramolecule building block is an aramid according to the following structure:

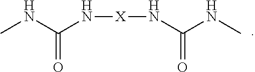

11. A process of forming a semicrystalline plastic composition comprising the steps of
dispersing a supramolecular building block bearing a reactive group in a semicrystalline plastic to form a mixture, wherein the semicrystalline plastic includes a polymeric chain; and
subjecting the mixture to reaction conditions that allow the supramolecular building block to be covalently linked to the polymeric chain of the semicrystalline plastic via a reaction between the reactive group of the supramolecular building block and the polymeric chain of the semicrystalline plastic.
